(19) United States
(12) Patent Application Publication
(10) Pub. No.: US 2026/0356390 A1
(43) Pub. Date: Nov. 12, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Jong Chul KIM, Gyeonggi-do (KR); Su Hyun KIM, Gyeonggi-do (KR); Byoung Joon LEE, Gyeonggi-do (KR); Eun Young CHOI, Gyeonggi-do (KR)

(73) Assignees: HYUNDAI MOTOR COMPANY, Seoul (KR); KIA CORPORATION, Seoul (KR)

(21) Appl. No.: 19/394,182

(22) Filed: Nov. 19, 2025

(30) Foreign Application Priority Data
May 7, 2025 (KR) 10 2025 0059034

(51) Int. Cl. B60W 60/00; B60W 10/20; B60W 30/09; B60W 30/095; B60W 30/12; B60W 30/18; B60W 40/09; B60W 50/16; B60W 50/14

(52) U.S. Cl. CPC B60W 60/001; B60W 10/20; B60W 30/09; B60W 30/0956; B60W 30/12; B60W 30/18163; B60W 40/09; B60W 50/16; B60W 2050/143; B60W 2050/146; B60W 2510/202; B60W 2540/18

(57) ABSTRACT

In a vehicle and a method for controlling the same, the autonomous vehicle control device includes a memory in which accumulated driving data of a driver is stored; and a processor electrically or adaptively connected to the memory, wherein the processor is configured to identify a driving tendency of the driver, which is related to a lateral control of the vehicle based on the driving data, and control steering of the vehicle while compensating for the driving tendency when driving of the vehicle is controlled by a system, and the driving tendency may include at least one of a first driving tendency, which represents a position of the vehicle biased with respect to a center portion of a lane while driving, and a second driving tendency, which represents a steering pattern of the driver during control of the steering.

### CROSS-REFERENCE TO RELATED APPLICATION

The present application claims priority to and the benefit of Korean Patent Application No. 10-2025-0059034, filed on May 7, 2025, the present disclosure of which is incorporated herein by reference in its entirety.

### BACKGROUND

### Field of the Present Disclosure

The present disclosure relates to a technology of operating steering control in a more efficient manner during autonomous driving.

### Discussion of Related Art

Conventional autonomous driving systems control vehicles by applying a predetermined steering control value during lane keeping and lane change but have limitations that the systems fail to account for individual driver preferences.

Furthermore, since conventional autonomous driving systems do not easily reflect a risk of collision with nearby objects in real time during steering control, there is a problem that safety and driving convenience can be lowered.

### BRIEF SUMMARY

The present disclosure is directed to performing control of the steering reflecting the driving tendencies of a driver and controlling the steering of a vehicle in consideration of cases in which a risk of collision is detected.

Objects of the present disclosure are not limited to the above objects, and other objects that are not described will be able to be clearly understood by those skilled in the art based on the following description.

A device for controlling an autonomous vehicle, according to various aspects of the present disclosure, may include: a memory in which accumulated driving data of a driver is stored; and a processor electrically or adaptively connected to the memory, wherein the processor may be configured to: identify a driving tendency of the driver, which is related to a lateral control of the vehicle based on the driving data; and control steering of a vehicle while compensating for the driving tendency when a system controls driving of the vehicle, and the driving tendency may include at least one of a first driving tendency which represents bias of a position of the vehicle with respect to a center portion of a lane while driving and a second driving tendency which represents a steering pattern of the driver during the controlling of the steering of the vehicle.

In the device, according to various aspects of the present disclosure, the processor may be configured to: set a lateral target position of the driver based on the first driving tendency; and control the steering of the vehicle to converge to the lateral target position within a predetermined lane.

In the device, according to various aspects of the present disclosure, the processor may be configured to: identify a steering control value determined by the system in a predetermined section; and control the steering of the vehicle while correcting the steering control value according to the second driving tendency of the driver.

In the device, according to various aspects of the present disclosure, the steering control value may include at least one of a steering angle, a steering angular velocity, and a steering torque.

In the device, according to various aspects of the present disclosure, the processor may be configured to: identify the steering control value determined by the system in the predetermined section; control the steering of the vehicle to converge to a set target steering value by a first time point when the second driving tendency of the driver is more aggressive than a predetermined reference; and control the steering of the vehicle to converge to the set target steering value by a second time point later than the first time point when the second driving tendency of the driver is more stable than the predetermined reference.

In the device, according to various aspects of the present disclosure, the processor may be configured to: control the steering of the vehicle to allow lane departure when the second driving tendency of the driver is more stable than a predetermined reference; and control the steering of the vehicle to prevent lane departure when the second driving tendency of the driver is more aggressive than the predetermined reference.

In the device, according to various aspects of the present disclosure, the processor may be configured to cancel a lane departure warning according to driving control by the system when the vehicle departs the lane.

In the device, according to various aspects of the present disclosure, the processor may be configured to: detect a risk of collision of the vehicle through a sensor unit of the vehicle; identify a risk value corresponding to the detected risk of collision; and control the steering of the vehicle differently when controlling the steering of the vehicle according to the risk value.

In the device, according to various aspects of the present disclosure, the processor may be configured to: terminate compensating for the driving tendency during control of the steering when the risk value is a preset first value or more than the preset first value; output a notification through an input/output interface of the vehicle when the risk value is greater than or equal to a second value greater than the first value; and terminate the control of the steering when the risk value is greater than or equal to a third value greater than the second value.

In the device, according to various aspects of the present disclosure, the processor may be configured to learn a driving pattern of the driver and determine the driving tendency of the driver based on a learned result.

In the device, according to various aspects of the present disclosure, the processor may be configured to output information related to at least one of the first driving tendency and the second driving tendency through an input/output interface of the vehicle.

In the device, according to various aspects of the present disclosure, the processor may be configured to control the steering of the vehicle while compensating for the driving tendency when driving control by the vehicle driver is changed to control by the system.

A method for controlling an autonomous vehicle, according to various aspects of the present disclosure, may include: identifying a driving tendency of a driver, which is related to a lateral control of the driver based on accumulated driving data of the driver; and controlling steering of a vehicle while compensating for the driving tendency when a system controls driving of the vehicle, wherein the driving tendency may include at least one of a first driving tendency which represents bias of a position of the vehicle with respect to a center portion of a lane while driving and a second driving tendency which represents a steering pattern of the driver during the controlling of the steering of the vehicle.

In the method, according to various aspects of the present disclosure, the controlling of the steering of the vehicle while compensating for the driving tendency may include: setting a lateral target position of the driver based on the first driving tendency; and controlling the steering of the vehicle to converge to the lateral target position within a predetermined lane.

In the method, according to various aspects of the present disclosure, the controlling of the steering of the vehicle while compensating for the driving tendency may include: identifying a steering control value determined by the system in a predetermined section; and controlling the steering of the vehicle while correcting the steering control value according to the second driving tendency of the driver.

In the method, according to various aspects of the present disclosure, the controlling of the steering of the vehicle while compensating for the driving tendency may include: identifying a steering control value determined by the system in a predetermined section; controlling the steering of the vehicle to converge to a set target steering value by a first time point when the second driving tendency of the driver is more aggressive than a predetermined reference; and controlling the steering of the vehicle to converge to the set target steering value by a second time point later than the first time point when the second driving tendency of the driver is more stable than the predetermined reference.

In the method, according to various aspects of the present disclosure, the method may further include: controlling the steering of the vehicle to allow lane departure when the second driving tendency of the driver is more stable than a predetermined reference; and controlling the steering of the vehicle to prevent lane departure when the second driving tendency of the driver is more aggressive than the predetermined reference.

In the method, according to various aspects of the present disclosure, the method may further include canceling a lane departure warning according to driving control by the system when the vehicle departs the lane.

In the method, according to various aspects of the present disclosure, the method may further include: detecting a risk of collision of the vehicle through a sensor unit of the vehicle; identifying a risk value corresponding to the detected risk of collision; and controlling the steering of the vehicle differently when controlling the steering of the vehicle according to the risk value.

In the method, according to various aspects of the present disclosure, the method may further include controlling the steering of the vehicle while compensating for the driving tendency when driving control by the vehicle driver is changed to control by the system.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic diagram of a vehicle according to an exemplary embodiment of the present disclosure;

FIG. 2 is a flowchart illustrating an operation of controlling vehicle steering while compensating for the driving tendencies of a driver according to an exemplary embodiment of the present disclosure;

FIG. 3 is a flowchart illustrating an operation of controlling vehicle steering based on a first driving tendency of the driver according to an exemplary embodiment of the present disclosure;

FIG. 4 is an exemplary view exemplarily illustrating an operation of controlling vehicle steering based on the first driving tendency of the driver according to an exemplary embodiment of the present disclosure;

FIG. 5 is a flowchart illustrating an operation of controlling vehicle steering based on a second driving tendency of the driver according to an exemplary of the present disclosure; embodiment of the present disclosure;

FIG. 6 is an exemplary view exemplarily illustrating an operation of controlling vehicle steering based on the second driving tendency of the driver according to an exemplary embodiment of the present disclosure;

FIG. 7 is a flowchart illustrating an operation of controlling vehicle steering based on a risk of collision according to an exemplary embodiment of the present disclosure;

FIGS. 8 and 9 are exemplary views exemplarily illustrating an operation of controlling vehicle steering according to a risk value.

### DETAILED DESCRIPTION OF EXEMPLARY EMBODIMENTS

Hereinafter, various exemplary embodiments of the present disclosure will be described in detail with reference to the accompanying drawings.

However, the technical idea of the present disclosure is not limited to various exemplary embodiments to be described but may be implemented in various different forms, and within the scope of the technical idea of the present disclosure, one or more of the components may be selectively combined or substituted between embodiments.

Furthermore, terms (including technical and scientific terms) used in the exemplary embodiments of the present disclosure may be interpreted as including a meaning that can be generally understood by a person including ordinary skill in the art to which the present disclosure pertains, unless explicitly defined and described otherwise, and commonly used terms such as those defined in dictionaries will be interpreted in consideration of the contextual meaning in the related art.

Furthermore, the terms used in the exemplary embodiments of the present disclosure are for describing the exemplary embodiments and are not intended to limit the present disclosure.

In the present specification, the singular form may include the plural form unless specifically stated otherwise in the context, and when described as “at least one (or one or more) of A, B, and C,” it may include one or more of all possible combinations of A, B, and C.

Furthermore, in describing the components of the exemplary embodiments of the present disclosure, terms such as first, second, A, B, (a), (b), etc., may be used. These terms are only for distinguishing the component from other components, and the essence, order, or sequence of the corresponding component is not limited by the term.

And, when a component is described as being 'connected', 'coupled', or 'joined' to another component, it may include not only the case where the component is directly connected, coupled, or joined to the other component, but also the case where it is 'connected', 'coupled', or 'joined' through another component between the component and the other component.

Furthermore, when described as being formed or disposed 'on (above)' or 'under (below)' each component, 'on (above)' or 'under (below)' includes not only the case where the two components are in direct contact with each other, but also the case where one or more other components are formed or disposed between the two components. Furthermore, when expressed as 'on (above)' or 'under (below)', it may include the meaning of not only the upward direction but also the downward direction with respect to one component.

In the various flowcharts of the present specification, at least some of the steps may be omitted or the mutual order may be changed, and at least some of the various embodiments of the present specification may be performed at a specific point in time of each step of the flowchart. The operations of the various flowcharts of the present specification may be performed by at least one of the control device 100, the processor 130, and the vehicle 10. Furthermore, redundant content in the drawings of the present specification may be omitted.

In the present specification, the 'autonomous driving system' or 'driver control assistance system' refers to hardware and software that can assist a driver in continuously controlling the longitudinal and lateral movements of a vehicle. Such a driver control assistance system may be referred to as a 'system' in the present specification.

In the present specification, 'Feature' may refer to a specific system function that provides assistance to the driver in a defined traffic scenario, situation, and within system boundaries.

In the present specification, 'Dynamic Control' may refer to performing the operational and tactical functions necessary to move the vehicle in real time. This may include control of the vehicle's lateral and longitudinal movements, monitoring of the road environment, responding to events in the road traffic environment, operational planning, and signaling.

In the present specification, 'System Boundaries' may refer to verifiable or measurable limits or conditions set by the manufacturer, up to or within the conditions that affect the ability of a system or system's function designed to provide assistance to the driver and for the system to operate as intended.

Hereinafter, various exemplary embodiments will be described in detail with reference to the accompanying drawings, but the same or corresponding components will be given the same reference numbers regardless of the drawing numbers, and redundant descriptions thereof will be omitted.

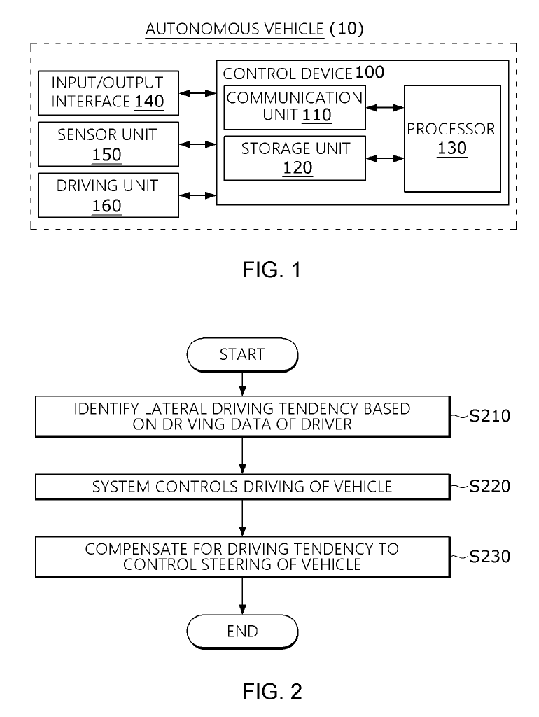

FIG. 1 is a schematic diagram of a vehicle 10 according to an exemplary embodiment of the present disclosure.

The vehicle 10 may include a control device 100 including a communication unit 110, a memory 120, and a processor 130, an input/output interface 140, a sensor unit 150, and a driving unit 160. Each of these components of FIG. 1 may be implemented inside the vehicle.

The control device 100 may be integrally formed with the internal components of the vehicle, or may be implemented as a separate independent device from other components inside the vehicle 10 and communicate with the internal components of the vehicle through various connection means (e.g., CAN bus, wireless network, wired connection, etc.). The control device 100 includes the communication unit 110, the memory 120, and the processor 130 to control the vehicle, and may additionally include other components such as the input/output interface 140, the sensor unit 150, and the driving unit 160 to perform complex control functions according to the driving situation. In the present specification, the control device 100 may be referred to as an autonomous vehicle control device 100.

The communication unit 110 may communicate with other control devices inside the vehicle to share data between systems or transmit and receive various information through connection with the outside of the vehicle. The communication unit 110 transmits control signals and data between internal components using various in-vehicle communication methods such as CAN communication, Ethernet, etc., and can link driving information and external data in real time through communication with a user terminal, other vehicles (V2V: Vehicle-to-Vehicle), infrastructure (V2I: Vehicle-to-Infrastructure), or an external server.

The communication unit 110 may perform short-range communication, Global Positioning System (GPS) signal reception, V2X (Vehicle-to-Everything) communication, optical communication, broadcast transmission/reception, and ITS (Intelligent Transport Systems) communication functions, and may support stable data transmission at close range using wireless communication technologies such as Bluetooth, Radio Frequency Identification (RFID), Infrared Data Association (IrDA), Ultra WideBand (UWB), ZigBee, Near Field Communication (NFC), Wi-Fi, Wi-Fi Direct, and Wireless USB. Furthermore, the communication unit 110 may include a mobile communication module based on a mobile communication network (LTE, 5G, etc.) and a wireless internet module for wireless internet access to receive real-time data through long-distance communication and improve the performance of the autonomous driving system by linking with the cloud.

The memory 120 may include various types of memory that can store data and may be integrated within the control device 100 or the processor 130 or configured as a separate module. The memory 120 may include non-volatile memory (e.g., hard disk drive, flash memory, etc.) and volatile memory, and may combine these to implement a memory system of various capacities and performances.

According to an exemplary embodiment of the present disclosure, the memory 120 may be configured to store and manage various data related to the steering control of the vehicle.

The memory 120 may store instructions that can drive various embodiments of the present disclosure. These instructions, when executed by the processor 130, may be configured to identify a driving tendency of the driver, which is related to lateral steering control based on the driving data, and control the steering of the vehicle while compensating for the driving tendency when a system controls driving of the vehicle.

The processor 130 communicates with various internal components of the communication unit 110, the memory 120, the input/output interface 140, the sensor unit 150, the driving unit 160, and the vehicle 10 through electrical or operational connections, and can control the operation of each component and perform data processing. The processor 130 is a central processing unit for executing instructions and determining data, and can perform vehicle control by collecting, processing, and analyzing data in real time according to the vehicle's driving environment.

The processor 130 may be implemented in a form of hardware, software, or a combination thereof, and may perform vehicle control logic in a form of a microcontroller, Field-Programmable Gate Array (FPGA), or Application-Specific Integrated Circuit (ASIC), for example. Furthermore, it may include a multi-processor configuration to control complex autonomous driving and driver assistance systems. The present processor configuration can support comprehensive vehicle control and stable performance through the execution of autonomous driving and assistance systems, sensor data processing, communication data management, and driving-related decision-making functions.

The input/output interface 140 is configured to receive input related to vehicle control from a user and to deliver the control state of the vehicle and system operation information to the user.

The input/output interface 140 can perform the function of receiving various inputs from the user and delivering the vehicle control state to the user. The input/output interface 140 may include input means and output means.

The input means may include physical buttons, selection areas on a touch display, voice recognition functions, gesture recognition functions, etc., through which the user can input commands such as autonomous driving system activation requests, function switching, or driving assistance settings.

The output means includes a display, an audio module (e.g., speaker), a haptic module, etc., and can provide the user with the status of the autonomous driving system, control transition request notifications, function activation status, etc., in visual, auditory, and tactile forms.

Furthermore, the input/output interface 140 can receive the driver's input through a touchscreen, physical buttons such as switches, a voice recognition system, etc. Through this, the driver can deliver commands such as activation of autonomous driving functions, changing warning settings, and canceling warnings to the vehicle system.

The sensor unit 150 may include a number of sensors that support the stable operation of the autonomous driving system or driver assistance system by detecting various driving and environmental information in real time. The sensor unit 150 can measure the distance and speed to surrounding objects through long-range detection sensors such as RADAR (Radio Detection and Ranging) and LiDAR (Light Detection and Ranging), and may include ultrasonic sensors to detect objects near to the vehicle 10.

The sensor unit 150 may include a camera. The camera can be classified into an external camera and an internal camera. The external camera recognizes the road and surrounding environment, and the internal camera can comprehensively grasp the situation inside and outside the vehicle by detecting the driver's state (e.g., eye tracking, steering wheel grip state, etc.) or the indoor situation. The sensor unit 150 may include a heart rate sensor, a pressure sensor, an infrared sensor, etc., to collect the driver's biometric information or various environmental data.

According to an exemplary embodiment of the present disclosure, the sensor unit 150 can detect various data to support the steering control of the vehicle 10. The sensor unit 150 may include a steering angle sensor to detect the current steering angle state of the vehicle in real time and an autonomous driving sensor that can detect the steering angle required for the scheduled autonomous driving function.

The steering angle sensor measures the steering angle data of the vehicle 10 to provide the current steering angle state in real time, and the autonomous driving sensor is configured to detect environmental data such as lane information around the vehicle, road structure, the position of front and rear vehicles, and the presence of obstacles to collect the target steering angle information required when activating the autonomous driving function.

Furthermore, the sensor unit 150 may include a lane detection sensor and a driving environment sensor that can detect the lateral position deviation of the vehicle 10 (distance from the center portion of the lane), heading (the vehicle's direction of travel), and road curvature.

The sensor unit 150 can deliver the detected current steering angle data and target steering angle data to the processor 130.

The driving unit 160 provides the driving force required for the driving of the vehicle 10 and may include various components that control the operation of the vehicle according to the commands output from the control device 100. The driving unit 160 may include devices that generate and transmit the power of the vehicle, such as an engine, motor, transmission, and wheel drive system, and a controller that is configured to control them, and through these components, acceleration, deceleration, and direction change of the vehicle 10 can be performed.

The driving unit 160 is controlled to maintain driving safety by performing longitudinal control (acceleration and deceleration) and lateral control (lane keeping and changing) of the vehicle. For example, it receives commands from the control device 100 to adjust the output of the motor or the rotation speed and direction of the wheels so that the vehicle can follow the driving path.

Furthermore, the driving unit 160 may include a brake system to reduce the vehicle's speed or stop it while driving. The driving unit 160 can control the vehicle 10 through an electric motor in the case of an electric vehicle, and based on engine output in the case of an internal combustion engine vehicle.

FIG. 2 is a flowchart illustrating an operation of controlling vehicle steering while compensating for the driving tendencies of a driver according to an exemplary embodiment of the present disclosure.

The control device 100 may identify driving tendencies, for example, a lateral driving tendency, based on the driving data of the driver (S210).

According to an exemplary embodiment of the present disclosure, the driving data of the driver may include at least one of steering record data of the vehicle 10, position data of the vehicle 10, acceleration/deceleration data of the vehicle 10, sensor-based environmental data, and manipulation pattern data of the driver.

The steering record data may include at least one of a past steering angle, past steering angular velocity, and past steering torque corresponding to the driver’s driving.

The position data may include a deviated position Oy within a lane driven by the vehicle, a distance from the center portion of the lane, etc.

Acceleration/deceleration data may include lateral acceleration and acceleration/deceleration patterns, and sensor-based environmental data may include the positions of nearby vehicles of the vehicle 10, a road curvature, a lane width, etc.

The manipulation pattern data of the driver may include the frequency of direct steering manipulations by the driver and the response speed to steering corrections.

The control device 100 may analyze the collected driving data of the driver to quantify or profile the driving tendencies of the driver.

According to an exemplary embodiment of the present disclosure, the lateral driving tendency may include at least one of the first driving tendency, which represents bias of the vehicle’s position with respect to a lane center portion while driving, and the second driving tendency, which represents the driver’s steering pattern during steering control.

The control device 100 may quantitatively analyze the driving tendencies of the vehicle 10 based on driving data and store the driving tendencies in a database (DB) to learn the driver’s patterns. The control device 100 may be configured to determine the driving tendencies of the driver based on these learning results.

The first driving tendency may be determined based on an average deflection distance d of the vehicle 10 from the center portion of the lane. In the instant case, the first driving tendency may be determined based on an average value or various other criteria.

For example, the control device 100 may analyze data from a predetermined time period (e.g., 100 km or one week of driving) and determine an average value of the deflection distance d of the vehicle 10 to set the first driving tendency of the driver.

Furthermore, the control device 100 may set the first driving tendency by applying greater weight to recent driving data. For example, an exponential moving average (EMA) method may be applied to reflect changes in the driver’s tendencies in real time.

Furthermore, the control device 100 may be configured to determine that the driving tendencies of the driver are consistent when the biased driving of the vehicle 10 continues for a predetermined time period (e.g., 30 seconds or more).

The control device 100 may identify the second driving tendency based on the driving data. The second driving tendency may be determined by analyzing variables, such as a steering angle speed (°/s), a steering angle acceleration (°/s²), a steering torque (N·m), and an average lateral acceleration (g), which are generated when the driver performs steering, and these variables may be stored in a database in multiple stages, allowing the second driving tendency to be determined for each driver in a specific stage.

For example, when a change in the steering torque is a predetermined value or less, it may be determined that the driving tendencies are stable. Furthermore, when the steering angle speed and the lateral acceleration rapidly change to predetermined values or more, the driving tendencies may be classified as aggressive steering tendencies.

These criteria may be continuously updated by storing the driving data of the vehicle 10 in the database (DB) and adjusted in real time according to changes in the driving tendencies of the driver. Furthermore, a machine learning-based model may be used to automatically learn the driving tendencies of the driver.

Furthermore, the second driving tendency is, for example, classified into “stable” and “aggressive,” but is not limited thereto and may be set to a plurality of levels, such as “very stable,” “stable,” “neutral,” “aggressive,” and “very aggressive.”

Next, the control device 100 may be configured for controlling the driving of the vehicle 10 using the system (S220).

According to an exemplary embodiment of the present disclosure, the system may automatically activate the driving control of the vehicle 10 when the driver manipulates a specific button or when a preset condition is satisfied.

For example, when the driver presses an autonomous driving activation button on a steering wheel or a dashboard, the system may start controlling the driving of the vehicle 10. Furthermore, the system may be automatically activated when the vehicle 10 is driving at a predetermined speed or higher or enters a specified driving environment, such as a highway.

The control device 100 may be configured for controlling the steering of the vehicle 10 while compensating for the driving tendencies (S230).

According to an exemplary embodiment of the present disclosure, when the driving control by the vehicle driver is changed to driving control by the system, the control device 100 may be configured for controlling the steering of the vehicle 10 while reflecting the driving tendencies of the driver.

According to an exemplary embodiment of the present disclosure, the control device 100 may perform the steering correction of the vehicle 10 while reflecting the lateral driving tendency of the driver and adjust the steering control method depending on the driving environment or a risk of collision.

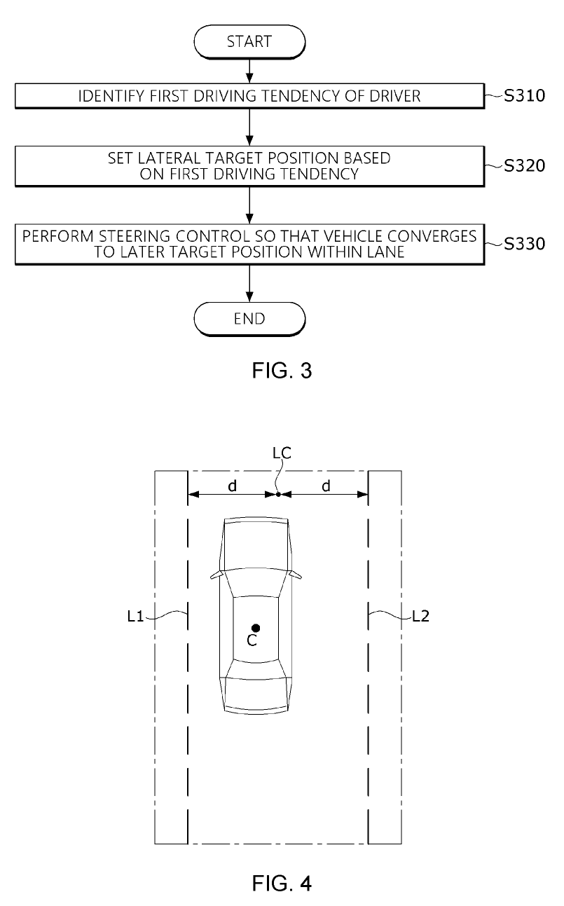

FIG. 3 is a flowchart illustrating an operation of controlling vehicle steering based on a first driving tendency of the driver according to an exemplary embodiment of the present disclosure. The description of FIG. 3 will be made with reference to FIG. 4. FIG. 4 is an exemplary view exemplarily illustrating an operation of controlling vehicle steering based on the first driving tendency of the driver according to an exemplary embodiment of the present disclosure.

The control device 100 may identify the first driving tendency of the driver (S310).

In an exemplary embodiment of the present disclosure, the first driving tendency may represent bias of the vehicle’s position with respect to the center portion of the lane while driving. The first driving tendency may be information included in the lateral driving tendency described in FIG. 2. The first driving tendency may indicate a position at which the driver maintains the vehicle 10 within a lane while driving.

The control device 100 may analyze the driving data of the vehicle 10 to determine whether the vehicle 10 travels in a predetermined direction biased with respect to the center portion of the lane. Furthermore, when the driver tends to consistently drive at a specific position without performing steering correction, it may be determined that the corresponding position is the first driving tendency of the driver.

The first driving tendency may be determined based on position data, a distance from the center portion of the lane, steering angle change patterns, and the like of the vehicle 10 and may be evaluated in conjunction with the driving environment or positions of nearby vehicles if necessary.

The control device 100 may set a lateral target position based on the first driving tendency (S320).

According to an exemplary embodiment of the present disclosure, the lateral target position represents a target position at which the vehicle 10 needs to drive within the lane and may be set to reflect the first driving tendency of the driver.

When the driving tendency of the driver is to tend to remain in the center portion of the lane, the control device 100 may set the lateral target position to the center portion of the lane. On the other hand, when the driving tendency of the driver to be biased in a specific direction within the lane is identified, the corresponding biased position may be set as the lateral target position.

Furthermore, the lateral target position may be adjusted based on the driving environment of the vehicle 10. For example, the target position may be fine-tuned in consideration of distances from nearby vehicles or a road width, and a more conservative target position may be set for specific road conditions (e.g., narrow lanes, highway entrances).

The control device 100 may be configured for controlling the steering of the vehicle 10 so that the vehicle 10 converges to the lateral target position Oy within the lane (S330).

Generally, an autonomous driving system may maintain a lane by minimizing an error between the road and the vehicle 10. To the present end, the system may identify a current lateral position and heading (driving direction) error of the vehicle 10 and determine an appropriate steering torque by reflecting a curvature of a road on which the vehicle 10 is driving. The steering torque may be controlled to allow the vehicle 10 to maintain its driving on a center portion of the lane or travel without deviating from the lane.

In various exemplary embodiments of the present disclosure, in addition to the autonomous driving-based lateral control, the driving tendencies (particularly, the first driving tendency) of the driver may be additionally reflected to correct steering so that the vehicle 10 ultimately converges to the lateral target position Oy.

That is, the steering torque of the vehicle 10 is determined based on conventional lane keeping control, but is further adjusted according to the driving tendencies of the driver. For example, when the driver exhibits the driving tendency biased in a specific direction within a lane, the system may adjust the steering of the vehicle 10 to the target position Oy that reflects the driving tendency of the driver rather than the center portion of the lane.

Referring to FIG. 4, a screen illustrating the vehicle 10 driving on a road including two lanes L1 and L2 is illustrated. The control device 100 may analyze a relative position of an arbitrary center point C of the vehicle 10 with respect to a center point Lc of the lane and control the steering of the vehicle 10 to be closer to a specific lane L1.

That is, the control device 100 may adjust the steering of the vehicle 10 based on the first driving tendency of the user so that the vehicle enables biased driving in a specific direction according to the driver’s tendency rather than simply balancing the vehicle at the center point Lc of the lane. When the driver prefers a position close to a specific side of the lane, the biased driving reflects the corresponding tendency so that the driver can keep the lane more naturally.

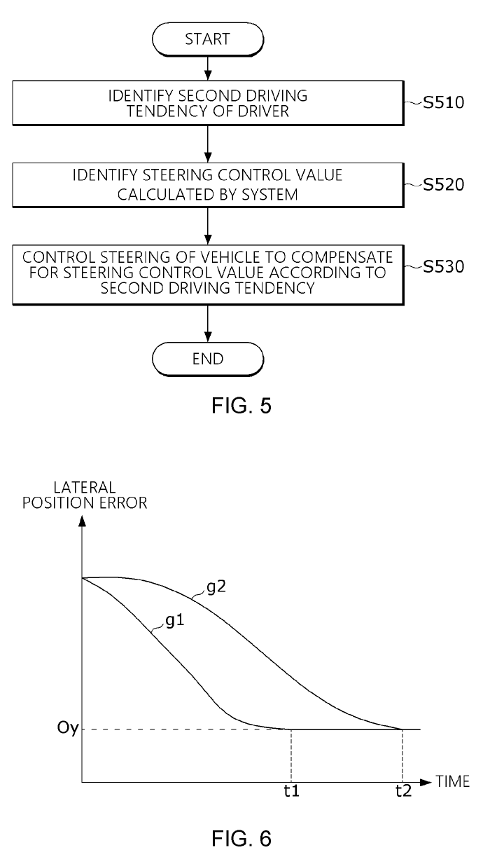

FIG. 5 is a flowchart illustrating an operation of controlling vehicle steering based on a second driving tendency of the driver according to an exemplary embodiment of the present disclosure. Description of FIG. 5 will be made with reference to FIG. 6. FIG. 6 is an exemplary view exemplarily illustrating an operation of controlling vehicle 10 steering based on the second driving tendency of the driver according to an exemplary embodiment of the present disclosure.

The control device 100 may identify the second driving tendency of the driver (S510).

According to an exemplary embodiment of the present disclosure, the second driving tendency may be related to the steering pattern exhibited by the driver when performing steering. This may be analyzed to determine whether the driver maintains a specific steering angle change pattern and whether the steering angle velocity is rapid or gradual.

The control device 100 may collect the steering data of the driver, and based on this, determine whether the driver steers smoothly while maintaining a predetermined steering torque or repeatedly makes rapid steering inputs. For example, when the exemplary steering response characteristic of the driver is a rapid change in steering angle, it may be determined that the second driving tendency is a more aggressive steering tendency. On the other hand, when the driver tends to gradually adjust the change in the steering angle, it may be determined that the second driving tendency is a more stable steering tendency.

Furthermore, the control device 100 may analyze the steering response of the driver, including a change in steering angle, a steering angle velocity, a steering torque, and the like, thereby quantitatively evaluating the steering characteristics of the driver. The second driving tendency may be reflected in the steering control of the vehicle 10 and used to adjust steering responsiveness according to the exemplary steering characteristics of the driver.

The control device 100 may identify a steering control value determined by the system (S520).

According to an exemplary embodiment of the present disclosure, the steering control value may include values such as a steering angle, steering angle speed, and steering torque set by the autonomous driving system in specific driving sections, such as lane keeping, lane changing, and curved driving.

These steering control values may be dynamically determined to reflect the driving conditions of the vehicle 10 and the road environment.

For example, the control device 100 or the autonomous driving system may be configured to determine the steering control value based on dynamic driving information, such as an acceleration, heading value, and lateral acceleration, of the vehicle 10 and road shape information, such as a lane curvature, a road slope, and a lane width.

Next, the control device 100 may be configured for controlling the steering of the vehicle 10 to correct the steering control value according to the second driving tendency (S530).

The control device 100 may identify the steering control value set by the autonomous driving system in specific sections requiring steering (e.g., a lane keeping section, a curve section, and the like) and adjust the steering control value to the second driving tendency of the driver.

According to an exemplary embodiment of the present disclosure, when the second driving tendency of the driver is more aggressive than a predetermined reference value, the steering angle speed and the steering torque may be increased to enable the vehicle 10 to perform a faster steering response and may be adjusted to converge to target steering values by a first time point.

In the instant case, the predetermined reference value may be “neutral” among the plurality of second driving tendency stages, and the second driving tendency of the driver may be “aggressive.”

On the other hand, when the second driving tendency of the driver is more stable (e.g., conservative) than the predetermined reference value, the steering angle velocity and the steering torque may be adjusted so that the steering response of the vehicle 10 becomes smoother, and the steering angle and the steering torque may converge to the target steering values by a second time point that is later than the first time point.

In the instant case, when the predetermined reference value is “neutral,” the second driving tendency of the driver may be “very stable.”

Furthermore, when the second driving tendency of the driver is more stable than the predetermined reference value, the control device 100 may adjust the lane keeping performance of the vehicle 10 to allow lane departure within a predetermined range during steering control.

In the instant case, the control device 100 may adjust a lane departure warning function automatically provided by the system. For example, when the steering tendency of the driver is set to allow lane departure, the lane departure warning of the system may be inactivated even when the vehicle 10 departs the lane, thereby preventing unnecessary warnings.

On the other hand, when the second driving tendency of the driver is more aggressive than the predetermined reference value, the lane centering performance can be enhanced so that the steering of the vehicle 10 is performed only within the lane.

In the instant case, when the possibility of the vehicle 10 leaving the lane is detected, the control device 100 may be configured to generate a lane departure warning.

In the present way, the control device 100 may identify the basic steering control value of the vehicle 10 and then adjust the basic steering control value according to the second driving tendency of the driver, thereby optimizing steering responsiveness and lane keeping performance.

Referring to FIG. 6, a lateral position error graph g1 of a vehicle of a first driver and a lateral position error graph g2 of a vehicle of a second driver over time are illustrated. In the example of FIG. 6, it is assumed that the first driver has a more aggressive driving tendency (e.g., the second driving tendency) than the second driver. Furthermore, it is assumed that the lateral target position Oy based on the first driving tendency of the first driver is the same as the lateral target position Oy based on the first driving tendency of the second driver.

The lateral position error may be a difference between a steering control value determined by the autonomous driving system in a specific section up to time point t2 and a current steering value (or position value) of the vehicle 10.

Referring to FIG. 6, it can be confirmed that the lateral position error graph g1 of the first driver reaches the lateral target position Oy earlier than the lateral position error graph g2 of the second driver.

This is because the first driver has a more aggressive driving tendency, and thus the steering control value is adjusted to more rapidly converge to the target value. Accordingly, when the second driving tendency of the driver is more aggressive, the steering control value of the vehicle 10 may be controlled to more rapidly converge to the target steering value, and when the second driving tendency of the driver is more stable, the steering control value of the vehicle 10 may be adjusted to more slowly converge to the target steering value.

In the present way, the control device 100 may analyze the driving tendency of the driver and reflect the corresponding driving tendency to adjust the steering control value of the vehicle 10, thereby providing a natural steering response that reflects the steering characteristics of the driver.

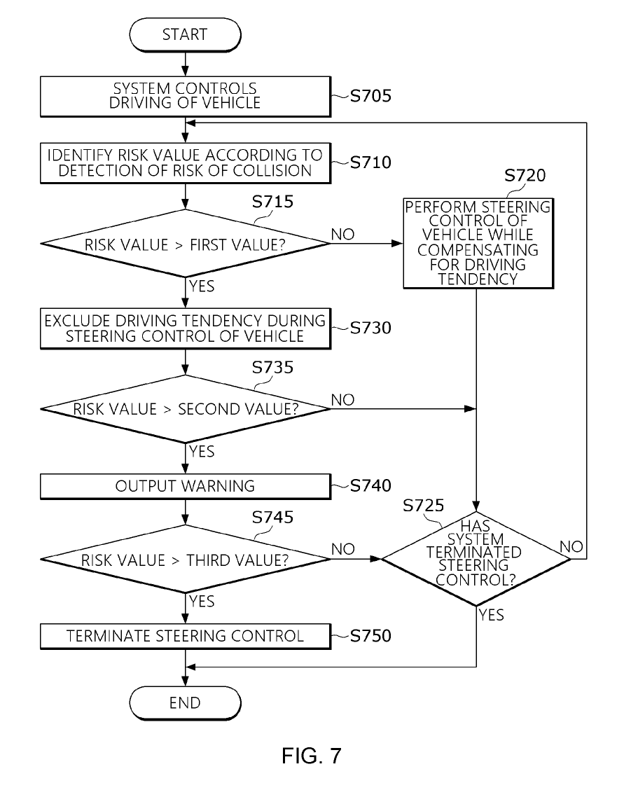

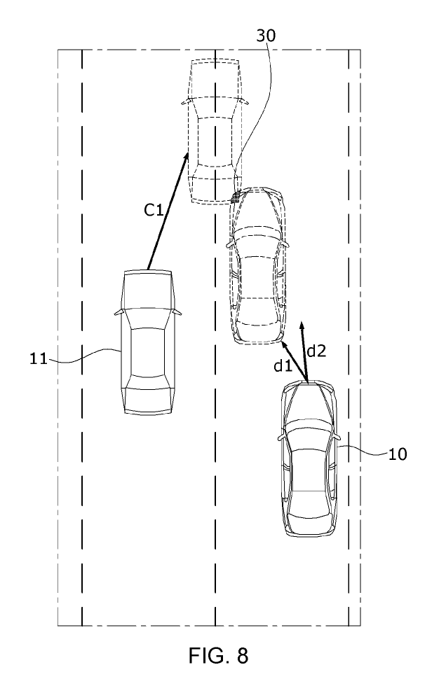

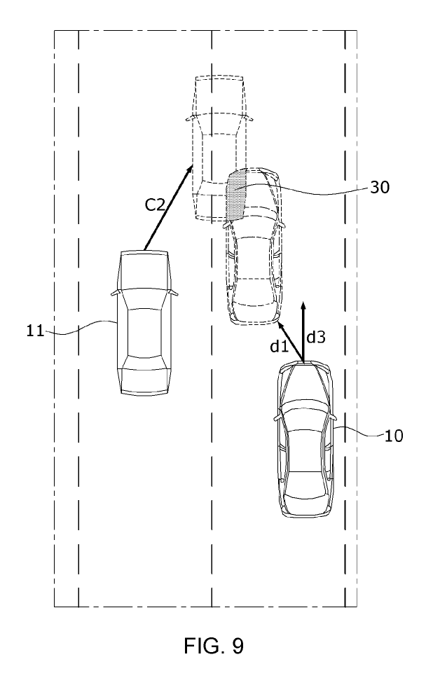

FIG. 7 is a flowchart illustrating an operation of controlling vehicle steering based on a risk of collision according to an exemplary embodiment of the present disclosure. The description of FIG. 7 will be made with reference to FIGS. 8 and 9. FIGS. 8 and 9 are exemplary views exemplarily illustrating an operation of controlling vehicle steering according to a risk value.

The control device 100 may be configured for controlling the driving of the vehicle using the autonomous driving system (S705).

The control device 100 may detect a risk of collision with nearby objects and identify or determine a risk value according to the detected signal (S710).

The control device 100 may detect the risk of collision of the vehicle 10 through the sensor unit 150. For example, the control device 100 may measure the distance and speed of the vehicle 10 to the nearby objects using a radar, a LiDAR, an ultrasonic sensor, and the like and determine the driving route of the vehicle 10 and driving routes of the nearby objects to detect the risk of collision.

Furthermore, the control device 100 may quantify the detected risk of collision and determine the risk of collision as a risk value.

For example, the control device 100 may obtain real-time data through the sensor unit 150 and identify a distance, speed, acceleration, the sizes of objects, and movement trajectory data collected from each sensor of the sensor unit 150.

The control device 100 may be configured to predict an estimated movement route after a predetermined time period based on a current speed and acceleration of the vehicle 10 and compare a moving direction, speed, and distance data of the nearby objects to filter an object with a high risk of collision. During the present process, the control device 100 may be configured to determine a time-to-collision (TTC) based on the obtained data.

The control device 100 may apply a risk prediction model that considers a road curvature, lane variability, and the like to determine the probability of the vehicle 10 colliding with nearby objects at a specific position as a probability value. In the instant case, the control device 100 may apply a machine learning-based risk evaluation model (e.g., a neural network or decision tree-based model).

The control device 100 may quantify a risk value based on the determined collision probability. In the instant case, the control device 100 may compare the quantified risk value with a predetermined threshold to set a risk level.

The control device 100 may be configured for controlling the steering of the vehicle 10 differently depending on the determined or determined risk value of the vehicle 10.

The control device 100 may be configured to determine whether the risk value according to the risk of collision of the vehicle 10 exceeds a preset first value (S715).

When the risk value is the preset first value or less (No in S715), the control device 100 may be configured for controlling the steering of the vehicle 10 to compensate for the driving tendencies of the driver (S720). That is, as in the above embodiments, the control device 100 may consider the driving tendencies of the driver when controlling the steering of the vehicle 10.

Conversely, when the risk value exceeds the preset first value (Yes in S715), the control device 100 may stop or exclude the reflection of the driving tendencies of the driver during steering control (S730).

For example, referring to FIG. 8, the vehicle 10 and nearby objects 11 are illustrated.

In the instant case, the objects 11 may include not only other vehicles, but also dynamic objects, such as pedestrians, bicycles, motorcycles, and the like and static objects, such as medians, guardrails, and road signs.

The control device 100 may be configured to predict the movement route of the vehicle 10 and determine an estimated position of the vehicle 10 after a predetermined time period. Furthermore, the control device 100 may analyze the speed, moving direction, road structure information, and the like of the object 11 obtained by the sensor unit 150 to determine the estimated position of the object 11 after the same time.

In the instant case, it is assumed that the control device 100 controls the steering of the vehicle 10 in a d1 direction in consideration of the driving tendencies of the driver during the controlling of the steering of the vehicle. Furthermore, in a driving situation along a lane as shown in FIG. 8, when the driving tendencies of the driver are not considered, it is assumed that the steering control of the vehicle 10 will be performed in a d2 direction thereof. Furthermore, it is assumed that an object 11 moves along a trajectory in a c1 direction thereof.

The control device 100 may compare estimated positions of the vehicle 10 and the object 11 to determine an intersection area 30 in which the possibility of intersection exists. The intersection area 30 is a space in which the vehicle 10 and the object 11 are likely to coexist and may be used to determine a risk value for evaluating the risk of collision.

For example, the control device 100 may be configured to determine a risk value according to the size and relative speed of the intersection area 30 using a predetermined risk value table.

Furthermore, the control device 100 may be configured to predict a risk value based on deep learning.

For example, the control device 100 may learn past collision data to automatically determine a risk value using the size of the intersection area 30 and the vehicle speed as input values. In the instant case, the input values may be the size of the intersection area, relative speed, approach angle, and changes in the positions of the vehicle 10 and the object 11, and the output value may be a risk value.

When the intersection area 30 exceeds the preset first value in consideration of factors such as the size of the intersection area 30, the relative speed of the vehicle 10 and the object 11, and an estimated moving distance after a change in steering, the control device 100 may be configured to determine that the corresponding driving route has a risk of collision.

Accordingly, the control device 100 may exclude steering control that reflects the driving tendencies of the driver in a situation such as that illustrated in FIG. 8 and control steering so that the vehicle 10 moves in the d2 direction that is a safer route. In the instant case, the control device 100 may be formed to follow the basic driving safety strategy set by the autonomous driving system of the vehicle 10 and may perform additional deceleration measures or emergency evasive maneuvers if necessary.

Next, the control device 100 may be configured to determine whether the risk value according to the risk of collision of the vehicle 10 exceeds a preset second value (S735). In the instant case, the second value may be set to be greater than the first value.

When the risk value according to the risk of collision exceeds the preset second value (Yes in S735), the control device 100 may output a warning (S740).

For example, when the risk value is the second value or more, the control device 100 may output a notification via the input/output interface of the vehicle 140.

Conversely, when the risk value due to the risk of collision does not exceed the preset second value (No in S735), the control device 100 may be configured to determine whether to terminate steering control by the system (S725). When steering control by the system is terminated based on a user input or a preset policy (Yes in S725), the operation of FIG. 7 may be terminated. Conversely, when steering control by the system is not terminated (No in S725), the control device 100 may re-determine the risk value as in operation S710.

Next, the control device 100 may be configured to determine whether the risk value according to the risk of collision of the vehicle 10 exceeds a preset third value (S745). In the instant case, the third value may be set to be greater than the second value.

When the risk value according to the risk of collision exceeds the preset third value (Yes in S745), the control device 100 may terminate the steering control of the vehicle 10 (S750).

For example, when the risk of collision is further increased due to the continued steering of the vehicle, the control device 100 may terminate steering correction of the vehicle 10 and prioritize deceleration or emergency braking of the vehicle.

For example, referring to FIG. 9, the vehicle 10 and the nearby objects 11 are illustrated.

The control device 100 may be configured to predict the movement route of the vehicle 10 and determine an estimated position of the vehicle 10 after a predetermined time period. Furthermore, the control device 100 may analyze the speed, moving direction, road structure information, and the like of the object 11 obtained by the sensor unit 150 to determine the estimated position of the object 11 after the same time.

In the instant case, it is assumed that the control device 100 controls the steering of the vehicle 10 in a d1 direction in consideration of the driving tendencies of the driver during the controlling of the steering of the vehicle. Furthermore, when steering control is terminated or excluded in a driving situation in a lane as shown in FIG. 8, it is assumed that the vehicle 10 maintains the d3 direction that is the current driving direction. Furthermore, it is assumed that an object 11 moves along a trajectory in a c2 direction thereof.

The control device 100 may compare estimated positions of the vehicle 10 and the object 11 to determine an intersection area 30 in which the possibility of intersection exists.

The intersection area 30 of FIG. 9 may be greater than the intersection area 30 of FIG. 8. Accordingly, the collision risk value of FIG. 9 may also be determined to be greater than the collision risk value of FIG. 8.

When the risk value determined or determined in FIG. 9 exceeds the third value, the control device 100 may terminate or exclude the steering control. Accordingly, the control device 100 may maintain the d3 direction that is a current driving trajectory direction and perform longitudinal control (e.g., acceleration or deceleration control) if necessary.

When the risk value according to the risk of collision does not exceed the preset third value (No in S745), the control device 100 may be configured to determine whether to terminate the steering control by the system (S725).

When steering control by the system is terminated based on a user input or a preset policy (Yes in S725), the operation of FIG. 7 may be terminated. Conversely, when steering control by the system is not terminated (No in S725), the control device 100 may re-determine the risk value as in operation S710.

According to the above embodiments, more stable vehicle driving control can be performed by performing lateral steering control in consideration of the driver’s tendencies.

According to exemplary embodiments of the present disclosure, by controlling a vehicle to consider a risk of collision while performing steering control reflecting the driving tendencies of a driver, it is possible to improve both precise steering control and driving stability.

Effects of the present disclosure are not limited to the above effects, and other effects that are not described will be able to be clearly understood by those skilled in the art based on the following description.

The term '~unit' as used in the exemplary embodiment of the present disclosure refers to software or a hardware component such as a field-programmable gate array (FPGA) or an application-specific integrated circuit (ASIC), and the '~unit' performs certain roles. However, '~unit' is not limited in meaning to software or hardware. A '~unit' may be configured to be in an addressable storage medium or configured to execute one or more processors. Thus, as an exemplary embodiment of the present disclosure, a '~unit' includes components such as software components, object-oriented software components, class components, and task components, and includes processes, functions, attributes, procedures, subroutines, segments of program code, drivers, firmware, microcode, circuitry, data, databases, data structures, tables, arrays, and variables. The functionality provided in components and '~units' may be combined into a smaller number of components and '~units' or further separated into additional components and '~units'. Furthermore, the components and '~units' may be implemented to execute one or more CPUs within a device or a secure multimedia card.

While the exemplary embodiments of the present disclosure have been described above, those skilled in the art will be able to understand that the present disclosure can be variously modified and changed within a scope that does not depart from the spirit and scope of the present disclosure as set forth in the claims below.

What is claimed is:

1. A device for controlling an autonomous vehicle, the device comprising:
a memory in which accumulated driving data of a driver is stored; and
a processor electrically or adaptively connected to the memory,
wherein the processor:
identifies a driving tendency of the driver, which is related to a lateral control of the vehicle based on the driving data; and
controls steering of the vehicle while compensating for the driving tendency based on that a system controls driving of the vehicle, and
wherein the driving tendency includes at least one of a first driving tendency which represents bias of a position of the vehicle with respect to a center portion of a lane while driving and a second driving tendency which represents a steering pattern of the driver during the controlling of the steering of the vehicle.

2. The device of claim 1, wherein the processor:
sets a lateral target position of the driver based on the first driving tendency; and
controls the steering of the vehicle to converge to the lateral target position within a predetermined lane.

3. The device of claim 1, wherein the processor:
identifies a steering control value determined by the system in a predetermined section; and
controls the steering of the vehicle while correcting the steering control value according to the second driving tendency of the driver.

4. The device of claim 3, wherein the steering control value includes at least one of a steering angle, a steering angular velocity, and a steering torque.

5. The device of claim 3, wherein the processor:
identifies the steering control value determined by the system in the predetermined section;
controls the steering of the vehicle to converge to a set target steering value by a first time point based on that the second driving tendency of the driver is more aggressive than a predetermined reference; and
controls the steering of the vehicle to converge to the set target steering value by a second time point later than the first time point based on that the second driving tendency of the driver is more stable than the predetermined reference.

6. The device of claim 1, wherein the processor:
controls the steering of the vehicle to allow lane departure based on that the second driving tendency of the driver is more stable than a predetermined reference; and
controls the steering of the vehicle to prevent the lane departure based on that the second driving tendency of the driver is more aggressive than the predetermined reference.

7. The device of claim 6, wherein the processor cancels a lane departure warning according to driving control by the system based on that the vehicle departs the lane.

8. The device of claim 1, wherein the processor:
detects a risk of collision of the vehicle through a sensor unit of the vehicle;
identifies a risk value corresponding to the detected risk of collision; and
controls the steering of the vehicle differently when controlling the steering of the vehicle according to the risk value.

9. The device of claim 8, wherein the processor:
terminates the compensating for the driving tendency during control of the steering based on that the risk value is a preset first value or more than the preset first value;
outputs a notification through an input/output interface of the vehicle based on that the risk value is greater than or equal to a second value greater than the first value; and
terminates the control of the steering based on that the risk value is greater than or equal to a third value greater than the second value.

10. The device of claim 1, wherein the processor learns a driving pattern of the driver and determines the driving tendency of the driver based on a learned result.

11. The device of claim 10, wherein the processor outputs information related to at least one of the first driving tendency and the second driving tendency through an input/output interface of the vehicle.

12. The device of claim 1, wherein the processor controls the steering of the vehicle while compensating for the driving tendency based on that driving control by the vehicle driver is changed to control by the system.

13. A method for controlling an autonomous vehicle, the method comprising:
identifying, by a processor, a driving tendency of a driver, which is related to a lateral control of the driver based on accumulated driving data of the driver; and
controlling, by the processor, steering of the vehicle while compensating for the driving tendency based on that a system controls driving of the vehicle,
wherein the driving tendency includes at least one of a first driving tendency which represents bias of a position of the vehicle with respect to a center portion of a lane while driving and a second driving tendency which represents a steering pattern of the driver during the controlling of the steering of the vehicle.

14. The method of claim 13, wherein the controlling of the steering of the vehicle while compensating for the driving tendency includes:
setting a lateral target position of the driver based on the first driving tendency; and
controlling the steering of the vehicle to converge to the lateral target position within a predetermined lane.

15. The method of claim 13, wherein the controlling of the steering of the vehicle while compensating for the driving tendency includes:
identifying a steering control value determined by the system in a predetermined section; and
controlling the steering of the vehicle while correcting the steering control value according to the second driving tendency of the driver.

16. The method of claim 13, wherein the controlling of the steering of the vehicle while compensating for the driving tendency includes:
identifying a steering control value determined by the system in a predetermined section;
controlling the steering of the vehicle to converge to a set target steering value by a first time point based on that the second driving tendency of the driver is more aggressive than a predetermined reference; and
controlling the steering of the vehicle to converge to the set target steering value by a second time point later than the first time point based on that the second driving tendency of the driver is more stable than the predetermined reference.

17. The method of claim 13, further comprising:
controlling, by the processor, the steering of the vehicle to allow lane departure based on that the second driving tendency of the driver is more stable than a predetermined reference; and
controlling, by the processor, the steering of the vehicle to prevent the lane departure based on that the second driving tendency of the driver is more aggressive than the predetermined reference.

18. The method of claim 17, further comprising:
canceling, by the processor, a lane departure warning according to driving control by the system based on that the vehicle departs the lane.

19. The method of claim 13, further comprising:
detecting, by the processor, a risk of collision of the vehicle through a sensor unit of the vehicle;
identifying, by the processor, a risk value corresponding to the detected risk of collision; and
controlling, by the processor, the steering of the vehicle differently based on that controlling the steering of the vehicle according to the risk value.

20. The method of claim 13, further comprising:
controlling, by the processor, the steering of the vehicle while compensating for the driving tendency based on that driving control by the vehicle driver is changed to control by the system.
